(19) United States
(12) Patent Application Publication
(10) Pub. No.: US 2009/0168113 A1
(43) Pub. Date: Jul. 2, 2009

(54) TRANSFERRING SCANNED DOCUMENTS

(75) Inventor: Michael Penkov, Maroubra (AU)

Correspondence Address: FITZPATRICK CELLA HARPER & SCINTO, 30 ROCKEFELLER PLAZA, NEW YORK, NY, 10112, US

(73) Assignee: Canon Information Systems Research Australia Pty. Ltd., North Ryde (AU)

(21) Appl. No.: 12/334,932

(22) Filed: Dec. 15, 2008

(30) Foreign Application Priority Data
Dec. 27, 2007 (AU) 2007260798

(51) Int. Cl. H04N 1/00

(52) U.S. Cl. 358/402

(57) ABSTRACT

A method of storing an electronic document on a computer. The computer is coupled to a system including at least one document handling device connected to the computer via a communications network. The method includes, in the document handling device, determining a user identity and scanning a document to generate the electronic document. The method also includes, in at least part of the system identifying the computer using the determined user identity, and causing the scanned electronic document to be transferred to the identified computer via the communications network, thereby the electronic document being stored on the identified computer.

### FIELD OF INVENTION

The present invention relates to a method and apparatus used in providing a scanned document to a user, and in particular to a method and apparatus for transporting a scanned document to a destination on a network.

### DESCRIPTION OF BACKGROUND ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Multifunction print devices (MFDs) are devices that integrate a number of hard-copy document handling functions, such as facsimile transceiver, scanner, copier and printer, in a single device. MFDs are often integrated into a computer network in the modern office environment allowing users to access MFD functions via personal computers coupled to the computer network, as well as via local inputs such as a touch-sensitive panel, or the like.

After a document is scanned at an MFD, the location of the scan data typically needs to be determined to allow the electronic version of the scanned document to be accessed. Ideally, this location needs to be: easily accessible from the MFD, so that the user does not spend an excessive amount of time searching for the location; easily accessible by the user after they leave the MFD, so that they can view the results of the scanning with minimum effort; and private, so that other users are not able to view the scan output.

A number of methods of dealing with this problem exist in prior art. For example, the user can specify their email address as the destination, as described in EP-1,292,095. This is easy to use at the MFD and ensures privacy. However, it isn't an efficient method of transport, as documents are first transferred to the email server, and then transferred the user's computer when they read the email. Most email servers have a limit on incoming email, and that limit is often too low for large scans. Additionally, it is difficult to access the scan output once the user leaves the MFD—they need an email account email client set up to download the scan data. Finally, the user's inbox becomes unnecessarily cluttered with scan output. Clearly, transferring scanned documents directly to the user's computer is a better alternative.

EP-1,193,592 describes another approach in which the user is provided with a list of previously defined destinations, allowing them to select a destination from that list. The list can contain destinations frequently scanned to, or destinations that were scanned to in the past. However, in such a case, the user is not able to scan to destinations not in the presented list and, if there is a large number of destinations, the list quickly becomes difficult to navigate.

Another method is to allow the user to browse a network and select a destination. While this allows greater flexibility than the previous approach, it requires substantial time, effort and knowledge of the network topology. Regular users would find such an approach too complicated and would not use it.

Another approach is to allow the user to select from a list of machines on the network, as described in EP-1,289,252. When transferring the file to the selected machine, a driver installed on the machine accepts the scanned data. Optionally, an application may be launched to handle the incoming scanned data. A disadvantage of this approach is that a separate driver needs to be installed on each target machine that is being used. In addition, the name of the machine they are using must be known to the user.

### SUMMARY OF THE INVENTION

It is an object of the present invention to substantially overcome, or at least ameliorate, one or more disadvantages of existing arrangements.

In a first broad form the present invention provides a method of storing an electronic document on a computer, the computer being coupled to a system including at least one document handling device connected to the computer via a communications network, and the method including:
(a) in the document handling device:
   (i) determining a user identity; and
   (ii) scanning a document to generate the electronic document;
(b) in at least part of the system:
   (i) identifying the computer using the determined user identity;
   (ii) causing the scanned electronic document to be transferred to the identified computer via the communications network, thereby the electronic document being stored on the identified computer.

In a second broad form the present invention provides a system for storing an electronic document on a computer, the system including at least one document handling device connected to the computer via a communications network, and wherein:
(a) the document handling device is for:
   (i) determining a user identity; and
   (ii) scanning a document to generate the electronic document;
(b) at least part of the system is for:
   (i) identifying the computer using the determined user identity;
   (ii) causing the scanned electronic document to be transferred to the identified computer via the communications network, thereby the electronic document being stored on the identified computer.

In a third broad form the present invention provides a method of providing a scanned document to a user, the method including, in a document handling device:
(a) scanning a document to generate scan data indicative of the scanned document;
(b) causing at least one computer associated with the user to be determined using a user identity; and,
(c) causing the scan data to be transferred to at least one computer. In a fourth broad form the present invention provides apparatus for providing a scanned document to a user, the apparatus including a document handling device for:
(a) scanning a document to generate scan data indicative of the scanned document;
(b) causing at least one computer associated with the user to be determined using a user identity; and,
(c) causing the scan data to be transferred to at least one computer.

In a fifth broad form the present invention provides a method of providing a scanned document to a user, the method including, in a system:
(a) receiving a user identity from a document handling device;
(b) determining at least one computer associated with the user using the user identity; and,
(c) causing scan data indicative of the scanned document to be transferred to the at least one computer.

In a sixth broad form the present invention provides apparatus for providing a scanned document to a user, the apparatus including a system for:
(a) receiving a user identity from a document handling device; and,
(b) determining at least one computer associated with the user using the user identity;
(c) transferring an indication of the at least one computer to the document handling device; and,
(d) causing scan data indicative of the scanned document to be transferred to at least one computer.

### BRIEF DESCRIPTION OF THE DRAWINGS

One or more embodiments of the invention will now be described with reference to the following drawings, in which:

FIG. 1 is a schematic diagram of an example of a networked environment containing a number of MFDs;

FIG. 2 is a schematic diagram of an example of an MFD;

FIG. 3 is a schematic diagram of an example of a computer system;

FIG. 4 is a flowchart of an example of a process for providing a scan data to a user;

FIG. 5 is a flowchart of a first example scenario for providing a scan data to a user;

FIG. 6 is a flowchart of a second example scenario for providing a scan data to a user;

FIG. 7 is a flowchart of an example of a method of transferring the scan output from an MFD to a known location on a known computer system;

FIG. 8 is a flowchart of an example of a method of transferring the scan output from an MFD to a known computer system where the location on the known computer system is determined automatically; and,

FIG. 9 is a screen diagram of an example of a screen that allows the user to select a computer system from a plurality of computer systems.

### DETAILED DESCRIPTION INCLUDING BEST MODE

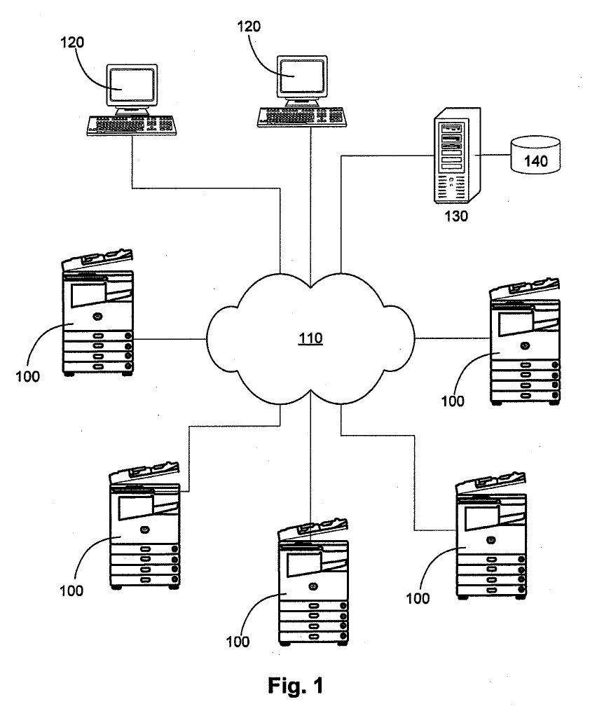

An example of a system used in providing scanned documents to a user will now be described with respect to FIG. 1.

In this example, the apparatus includes a number of Multi-Function Devices (MFDs) 100, coupled to a number of computers 120, and optionally a number of servers 130, via a communications network 110. The servers may also be coupled to one or more databases 140, as shown.

In use, the MFDs 100 are used to perform various document handling jobs, such as printing, scanning, copying, or faxing of documents, or the like. As part of this process, the computers 120 may be used to provide documents to the MFDs 100, for example in the case of printing applications, or may be used to display job results, for example following scanning of the documents by the MFDs 100.

Similarly, the servers 130 may be used to provide or receive documents used in jobs, as well as to provide additional network based activities, such as user authentication, document storage, file and print management and personal contacts management, and this may require interaction with data in the database 140.

It will therefore be appreciated that a wide range of network architectures are encompassed by the system and the configuration shown is for the purpose of example only.

Thus, for example, the communications network may be any suitable communications network, but is typically a Local Area Network (LAN) 110 such as an intranet, although may also include a Wide Area Network, the Internet, or the like. Furthermore, any number of MFDs 100, computers 120, or servers 130 may be used, and the number shown is for the purpose of illustration only.

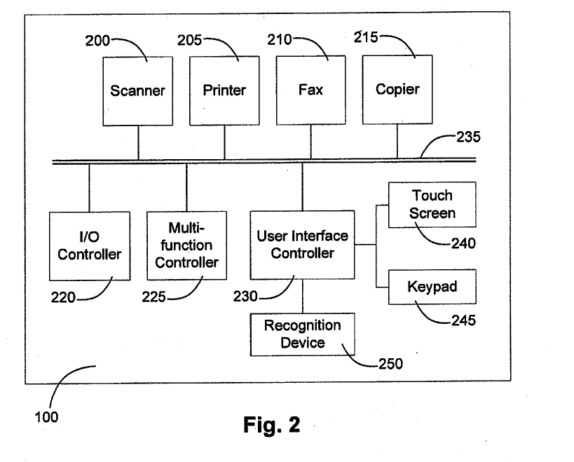

An example of one of the MFDs 100 is shown in more detail in FIG. 2.

In this example, the MFD includes a scanner 200, a printer 205, a fax 210 unit, an optional dedicated copier 215, an Input/Output (I/O) controller 220, a multi-function controller 225, and a user interface controller 230, coupled together via a bus 235, as shown.

The user interface controller 225 is typically coupled to one or more user interface devices, such as a touch screen 240 and keypad 245, to allow a user to view information provided by the MFD 100 and provide appropriate input commands. A recognition device 250 may also be provided for obtaining information for identifying users. This may include for example a biometric scanning device, or a swipe card or RFID (Radio Frequency Identification) tag reader for reading information from a suitable swipe card or RFID tag.

In use, the I/O controller 220 operates to handle interaction with external devices, such as the network 110, whilst the multi-function controller 225 operates to control the scanner 200, printer 205, fax 210 and copier 215, to allow desired jobs to be performed. It will therefore be appreciated that the controllers are typically implemented as software executed by a suitable processor, which is operating under control of appropriate software applications stored in a store (not shown).

In one example, the method described in more detail below may be performed through the use of a suitable module loaded into the processor from memory, and this is typically implemented by the multifunction controller 225. This may be achieved in any one of a number of manners, but in one example may be achieved using a JAVA module that activates a graphical user interface (GUI) on the touch screen 240, and interacts with the computer 120 and/or the servers 130 as required. This allows the MFD 100 to scan documents and communicate with the computers 120, servers 130 and databases 140 as required, in order to allow the scanned document to be transferred to a computer associated with the user, as scan data.

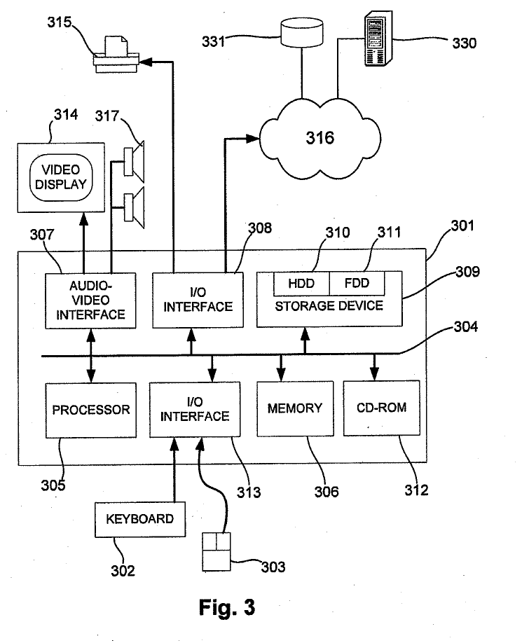

An example of a general-purpose computer 120 is shown in FIG. 3.

The computer system 300 is formed by a computer module 301, input devices such as a keyboard 302 and mouse 303, and output devices including a printer 315, a display device 314 and loudspeakers 317.

The computer module 301 typically includes at least one processor unit 305, and a memory unit 306, for example formed from semiconductor random access memory (RAM) and read only memory (ROM). The module 301 also includes an number of input/output (I/O) interfaces including an audio-video interface 307 that couples to the video display 314 and loudspeakers 317, and an I/O interface 313 for the keyboard 302 and mouse 303 and optionally a joystick (not illustrated). An I/O interface 308, such as a network interface card (NIC) is also typically used for connecting to the computer to the network 110.

A storage device 309 is provided and typically includes a hard disk drive 310 and a floppy disk drive 311. A magnetic tape drive (not illustrated) may also be used. A CD-ROM drive 312 is typically provided as a non-volatile source of data.

The components 305 to 313 of the computer module 301, typically communicate via an interconnected bus 304 and in a manner that results in a conventional mode of operation of the computer system 300 known to those in the relevant art. Examples of computers on which the described arrangements can be practised include IBM-computer's and compatibles, Sun Sparcstations or the like.

The processes used when of performing jobs, such as viewing scanned documents, are typically implemented using software, such as one or more application programs executing within the computer system 300. Typically, the application activates a GUI on the video display 314 of the computer system 300 which displays the scanned documents.

In particular, the methods and processes are affected by instructions in the software that are carried out by the computer. The instructions may be formed as one or more code modules, each for performing one or more particular tasks. Typically the execution of the instructions may require a number of different application programs to interact, and may also require the presence of a suitable driver that is configured to operate with a specific device or MFD.

The software may be stored in a computer readable medium, and loaded into the computer, from the computer readable medium, to allow execution. A computer readable medium having such software or computer program recorded on it is a computer program product. The use of the computer program product in the computer preferably affects an advantageous apparatus for distributed printing, scanning or copying.

The term “computer readable medium” as used herein refers to any storage or transmission medium that participates in providing instructions and/or data to the computer system 300 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 301. Examples of transmission media include radio or infra-red transmission channels as well as a network connection to another computer or networked device, and the Internet or Intranets including e-mail transmissions and information recorded on Websites and the like.

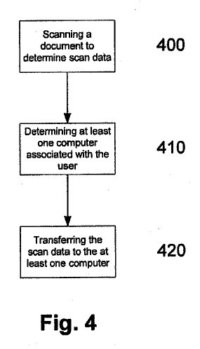

An example of a method for use in providing a scanned document to a user will now be described with reference to FIG. 4.

In this example, at step 400, a document handling device, such as an MFD 100, scans a document to generate scan data, which is an electronic representation of the scanned document. At step 410, the document handling device causes at least one computer associated with the user to be determined using a user identity. It will be appreciated that these steps may be performed in any order, so determining which computer is associated with a user can take place before or after the scanning is performed.

Following this, at step 420, the document handling device can cause the scan data to be transferred to the at least one computer via the communications network 110.

It will be appreciated that these steps can be performed in a number of manners.

The computer may be a computer 120 that the user is currently using, or logged in to, and can be determined using any suitable mechanism. Thus, for example, the document handling device can query a system including the network 110, and/or any processing systems coupled thereto, such as the server 130, or the like. In this instance, the system returns an indication of the least one computer, allowing the document handling device to transfer the scan data thereto. Alternatively, the document handling device can forward the user identity and scan data to the system, allowing the system to determine the at least one computer, and transfer the scan data thereto.

The user identity is typically provided by the user, for example by having the user supply a username, biometric data or the like, and may be provided by the user during an authentication process, or similar.

The scan data is typically stored on the computer in memory 306, or on the storage device 309, and can be provided in a predefined or a user defined location, such as Desktop, My Documents, My Scans on Windows machines and $HOME on Linux machines. The location can be determined based on user profile or environment variables.

The scan data can be provided with a specific filename and this can be constructed in a pre-determined way, such as by concatenating a timestamp and number of pages, or can be defined by the user using an on-screen keyboard or otherwise.

Once the scan data has been stored, an indication of the location and/or filename can be sent to the user. This can be performed either by the document handling device and/or the system, and can be achieved in any suitable manner such as by email, SMS, or the like.

It will therefore be appreciated that the above described process provides a method of allowing scanned documents to be provided to a user. In one example, this occurs when a user scans a document at an MFD and wishes to transport the scanned document to a PC on the network.

In this instance, the MFD communicates with the network environment to which it is connected, to allow a computer associated with the user to be determined. The scan data representing the scanned document can be transferred directly to the identified user computer, for subsequent retrieval by the user. This allows the user to perform this task without knowing the details of the network topology or spending significant time and effort, thereby providing an approach that provides privacy and ease of access.

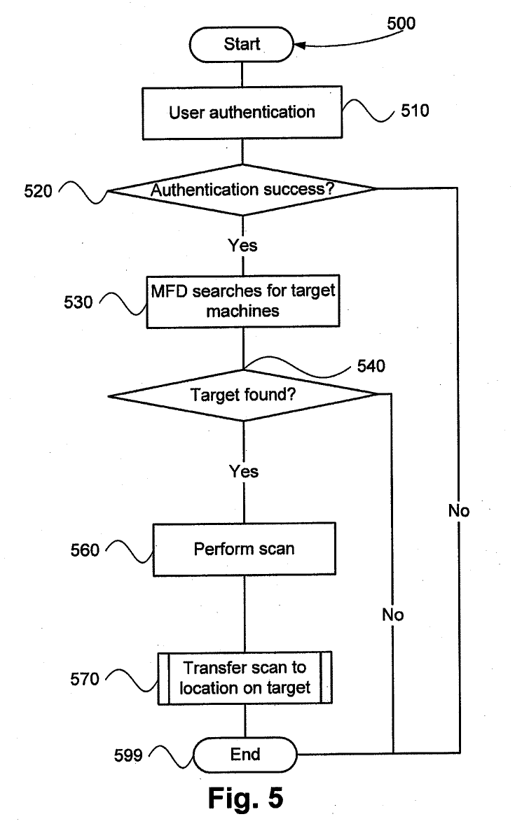

A first example scenario will now be described with reference to FIG. 5.

The example scenario comprises an environment with a plurality of personal computers (PCs) 120 and Multi-Function Devices (MFDs) 100—connected by a network (e.g. Ethernet or wireless) 110. Users perform the majority of their tasks (word processing, browsing the internet) at the PCs 120, and occasionally go to the MFDs 100 for tasks such as printing, copying and scanning.

In the example scenario, all users have a personal profile containing:
Email address
Phone number
Privileges set (network resources, directory and file permissions, etc)

To use a PC 120, the users must first authenticate themselves at the PC 120. Authentication can be performed by presenting authentication information such as a username and password pair, a smart card, biometric data, or otherwise. Upon successful authentication, the user is considered to be logged in to the PC 120. The PC 120 retrieves their personal profile and the user may use the PC 120 to the extent that the privileges set in their personal profile allow them to.

The personal profile can thus be moved from one device to another, as demonstrated by the ‘Roaming Profile’ concept in Microsoft Windows NT systems. Using such an approach, the roaming user profile is downloaded from the domain controller, such as a server 130, onto the local computer 120 and applied when a user logs onto a PC 120. When the user logs off, the changes made to the roaming profile are transferred back to the domain controller. One of advantages of such an approach is that the domain controller is able to keep track of what PCs 120 requested the user profiles for a particular user, and what PCs 120 have not yet been transferred back the user profile to the domain controller for the user. This allows the domain controller, such as the server 130, to keep track of what PCs 120 are being used, and the users logged in to each PC 120. In this instance, when it is required to determine any computers associated with the user, this can be achieved by querying the domain controller.

Other methods of searching for computers that a user is logged into exist, such as querying each PC 120 on the network 110 for the list of users that are currently logged in and determining whether or not the user is in the logged in user list. However. for the purpose of the example scenario, the domain controller approach with remote profiles will be used.

In this example scenario, the concept of a PC 120 being associated with a user will be defined as the user using or being currently logged into a PC 120. However, it is clear that the scenario can easily be adapted other situations, such as the association occurring when a user has a user profile on a PC 120.

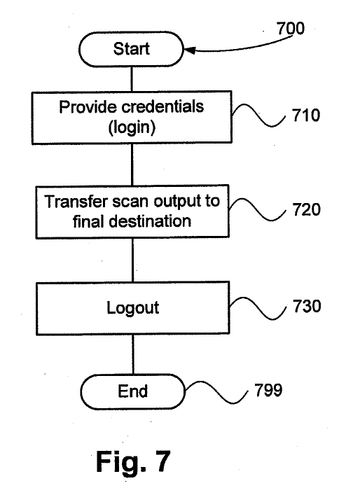

It is common practice to transfer files to a remote PC 120 on a network such as the network 110. Example protocols facilitating such transfers are SMB (Windows), Samba (Linux) or NFS (Network File System) for Linux. An example process for transferring files to a computer will now be described with reference to FIG. 7.

In order to transfer a file to a remote computer, identification information for the PC 120, such as a hostname or IP address must first be known. Furthermore, credentials sufficient for accessing the PC 120 are also required. Typically, the credentials of a user on the PC 120, or credentials of a network administrator may be used.

The computer identification information and the credentials are used to log in at step 710. Then, location information corresponding to a directory on the remote PC 120 is determined. The file can then be transferred to the location at step 720, and the user logs off at step 730 to stop using the remote PC 120.

The manner in which location information is determined will vary. For example, a default directory may be used, such that the document may be stored in a directory that that is commonly accessed (e.g. c:\temp on Windows systems, or /tmp on Linux systems). The location information can also typically be obtained through browsing.

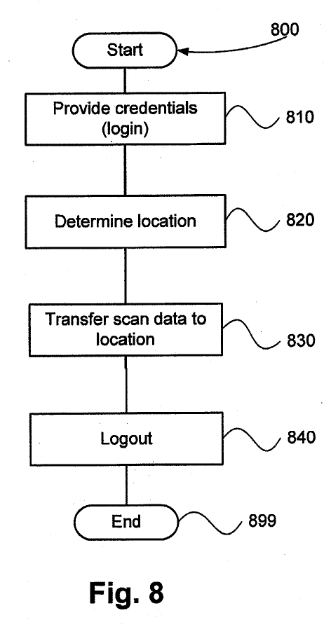

An example of another mechanism for determining location information will now be described with reference to FIG. 8.

First, the user logs in to a remote PC 120 at step 810. Environmental variables are then used to determine output location information at step 820. For example, on Windows, the location of the user profile directory is stored in the % USERPROFILE % environmental variable. The value of this environmental variable is updated from the roaming user profile when the user logs on. Similarly, on Linux, the user's home directory is stored in $HOME and is set when the user logs in to the PC. In addition, on Windows machines, the system registry may also be used. Finally, the scan file can be transferred to said determined location at step 830 and the user logs out at step 840.

There also exist methods for allowing a user logged into one PC to access a remote PC automatically, that is, without presenting authentication information manually, such as Integrated Windows Authentication. While currently this only applies to Internet browsing, such a concept may be theoretically extended to general network access, involving all network devices supporting authentication, such as MFDs. Such methods greatly simplify access for authenticated users.

To use an MFD 100, the users must also authenticate themselves. As for PCs 120, authentication at an MFD 100 can be performed by presenting authentication information such as a username and password pair, a smart card, biometric data, or otherwise. It is important to note that the same authentication information may be used for logging into a PC 120 and an MFD 100. It is also important to note that the authentication information provided by a user at the MFD 100 may be re-used to authenticate them at a PC 120 while the user is still at the MFD 100 without further manual input. This re-usability is a property of the environment—if this property does not exist, then other methods for authentication at the PC may be used, such as Integrated Windows Authentication.

Depending on the environment, users may or may not use a plurality of devices at the same time.

In the example of FIG. 5, a user uses only one PC 120 and at most one MFD 100 at the same time. The PC 120 currently used by the user is referred to as the user's workstation for the purposes of this example. The scenario begins at step 500 after the user approaches the MFD 100. The user authenticates themselves at step 510, using one of the methods described above or otherwise.

In the case of authentication success at step 520, the user's credentials and personal profile becomes available to the MFD 100. The MFD 100 then searches at step 530 for PCs 120 currently associated with the user, such as a PC 120 that the user is using, by contacting the domain controller. As in this particular example each user may use only one PC 120, the MFD 100 locates the user's workstation at step 540. The document is then scanned at step 560) and transferred at step 570 to the user's workstation 120. This transfer may be performed using one of the methods described above, in reference to FIG. 7 and FIG. 8.

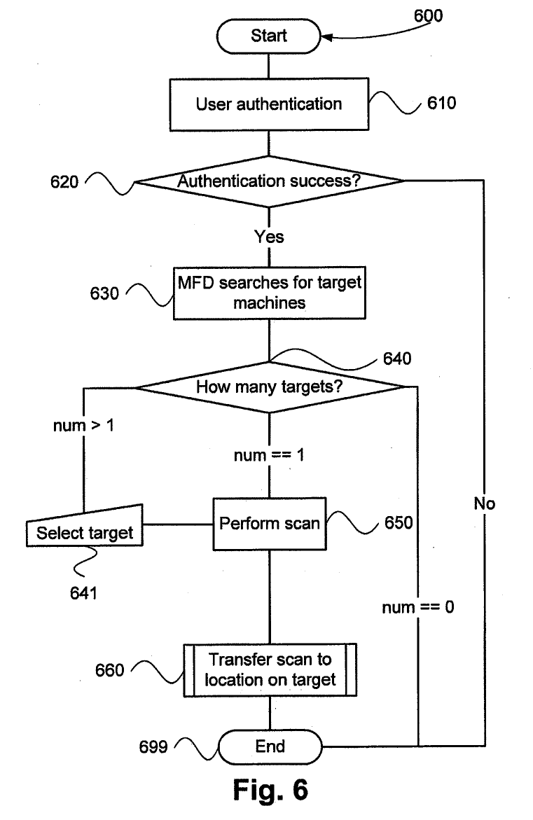

The example of FIG. 6 is similar to the previous example and similar steps will not therefore be described in detail. The main difference in this example is that the restriction on users using at most one PC 120 is lifted. Accordingly, after the MFD 100 searches for target PCs 120 at step 630, it checks the number of found targets at step 640. In the case that more than one target is found, the user is asked to select one or more targets at step 641. This may be accomplished through the use of a suitable user interface presented to the user on the MFD, for example using the touch screen 240.

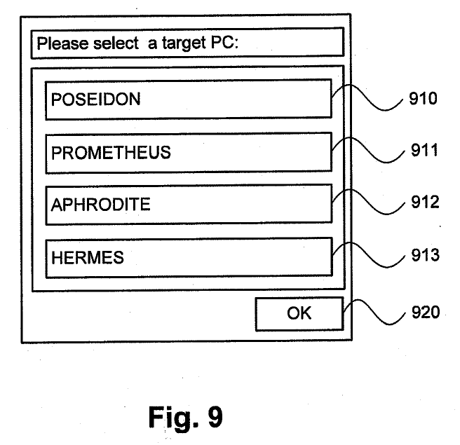

An example interface is shown in FIG. 9. In this example, the distinction between PCs 120 is made by hostname, although other methods may be used (e.g. geographical location, available hard drive space, etc). The hostnames are presented on the user interface as selectable hostname indications 910, 911, 912, 913, allowing the user to select one or more hostname indications 910, 911, 912, 913 and then select an OK input command 920.

The scan data can then be transferred to the computers identified by the selected hostnames at step 660.

In the case that only one PCs is found at step 840, this example is identical to the previous example.

Accordingly, the above described processes allow a user to authenticate themselves at an MFD 100 by providing user credentials, such as an access card or a username-password pair. The user details (such as username) become known to the MFD 100, allowing the MFD 100 to cause a computer currently associated with the user to be identified, using the user credentials. The association relationship between the user and a computer may be defined for example as the user being logged into that computer, or the user having a user profile at that machine, and is typically determined by querying a system in the network environment, such as a domain controller. The MFD 100 can then transfer the scanned document to the identified computer(s), for subsequent retrieval by the user.

The term document processing is intended to encompass any document processing function utilising, at least in part, a hard copy document. The term therefore encompasses functions such as scanning, copying, printing and faxing of documents.

It will be appreciated from this that whilst the above examples have been described with respect to MFDs, the techniques may be applied to any devices that are capable of performing scan jobs.

The system is understood to include any one or more of the processing systems provided in the network environment, including but not limited to one or more of the computers 120, the servers 130, and the controllers implemented within the MFDs 100, as well as any processing functionality of the network 110.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

The claims defining the Invention are as follows:

1. A method of storing an electronic document on a computer, the computer being coupled to a system including at least one document handling device connected to the computer via a communications network, and the method including:
(a) in the document handling device:
(i) determining a user identity; and
(ii) scanning a document to generate the electronic document;
(b) in at least part of the system:
(i) identifying the computer using the determined user identity;
(ii) causing the scanned electronic document to be transferred to the identified computer via the communications network, thereby the electronic document being stored on the identified computer.

2. The method of claim 1, where the determined user identity is used to authenticate the MFD to the machine prior to transferring the scanned electronic document.

3. The method of claim 1, where the process of identifying the computer using the determined user identity is performed by querying every computer on the network.

4. The method of claim 1, where the process of identifying the computer using the determined user identity is performed by contacting a remote server.

5. The method of claim 1, further comprising the user specifying the filename of the scanned electronic document prior to it being transferred to the identified computer.

6. The method of claim 1, further comprising the step of determining a user-specific location on the identified computer using the determined user identity and transferring the scanned electronic document to the user-specific location on the identified computer.

7. The method of claim 1, further comprising the step of selecting a single computer from a plurality of computers after the plurality of computers has been identified using the determined user identity.

8. The method of claim 1, further comprising the step of sending the stored location and/or a filename of the scanned electronic document to the user.

9. The method of claim 8, where the stored location and/or a filename is sent via email.

10. The method of claim 8, where the stored location and/or a filename is sent via SMS.

11. A system for storing an electronic document on a computer, the system including at least one document handling device connected to the computer via a communications network, and wherein:
(a) the document handling device is for:
(i) determining a user identity; and
(ii) scanning a document to generate the electronic document;
(b) at least part of the system is for:
(i) identifying the computer using the determined user identity;
(ii) causing the scanned electronic document to be transferred to the identified computer via the communications network, thereby the electronic document being stored on the identified computer.

12. A method of providing a scanned document to a user, the method including, in a document handling device:
(a) scanning a document to generate scan data indicative of the scanned document;
(b) causing at least one computer associated with the user to be determined using a user identity; and,
(c) causing the scan data to be transferred to at least one computer.

13. The method of claim 12, wherein the method includes, in the document handling device:
(a) transferring the user identity to a system including a communications network for coupling the computer to the document handling device, at least part of the system being for determining at least one computer using the user identity; and,
(b) receiving an indication of the at least one computer from the system.

14. The method of claim 12, wherein the method includes, in the document handling device:
(a) determining a plurality of computers;
(b) displaying an indication of the plurality of computers to the user, to allow user selection of at least one computer; and,
(c) causing the scan data to be transferred to at least one selected computer.

15. Apparatus for providing a scanned document to a user, the apparatus including a document handling device for:
(a) scanning a document to generate scan data indicative of the scanned document;
(b) causing at least one computer associated with the user to be determined using a user identity; and,
(c) causing the scan data to be transferred to at least one computer.

16. A method of providing a scanned document to a user, the method including, in a system:
(a) receiving a user identity from a document handling device;
(b) determining at least one computer associated with the user using the user identity; and,
(c) causing scan data indicative of the scanned document to be transferred to the at least one computer.

17. The method of claim 16, wherein the method includes, in the system, transferring an indication of the at least one computer to the document handling device.

18. Apparatus for providing a scanned document to a user, the apparatus including a system for:
(a) receiving a user identity from a document handling device; and,
(b) determining at least one computer associated with the user using the user identity;
(c) transferring an indication of the at least one computer to the document handling device; and,
(d) causing scan data indicative of the scanned document to be transferred to at least one computer.
